(19) United States
(12) Patent Application Publication
(10) Pub. No.: US 2019/0354850 A1
(43) Pub. Date: Nov. 21, 2019

(54) IDENTIFYING TRANSFER MODELS FOR MACHINE LEARNING TASKS

(71) Applicant: International Business Machines Corporation, Armonk, NY (US)

(72) Inventors: Patrick Watson, Montrose, NY (US); Bishwaranjan Bhattacharjee, Yorktown Heights, NY (US); Noel Christopher Codella, White Plains, NY (US); Brian Michael Belgodere, Fairfield, CT (US); Parijat Dube, Yorktown Heights, NY (US); Michael Robert Glass, Bayonne, NJ (US); John Ronald Kender, Leonia, NJ (US); Siyu Huo, White Plains, NY (US); Matthew Leon Hill, New York, NY (US)

(21) Appl. No.: 15/982,622

(22) Filed: May 17, 2018

(51) Int. Cl. G06N 3/08; G06N 5/02; G06N 99/00

(52) U.S. Cl. CPC G06N 3/08; G06N 99/005; G06N 5/02

(57) ABSTRACT

Techniques regarding autonomously facilitating the selection of one or more transfer models to enhance the performance of one or more machine learning tasks are provided. For example, one or more embodiments described herein can comprise a system, which can comprise a memory that can store computer executable components. The system can also comprise a processor, operably coupled to the memory, and that can execute the computer executable components stored in the memory. The computer executable components can comprise an assessment component that can assess a similarity metric between a source data set and a sample data set from a target machine learning task. The computer executable components can also comprise an identification component that can identify a pre-trained neural network model associated with the source data set based on the similarity metric to perform the target machine learning task.

### BACKGROUND

The subject disclosure relates to the identification of transfer models for machine learning tasks, and more specifically, to autonomously identify one or more pre-trained neural networks to be selected for transfer learning to enhance the performance of one or more machine learning tasks.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can autonomously identify one or more pre-trained neural networks to be selected for transfer learning to enhance the performance of one or more machine learning tasks are described.

According to an embodiment, a system is provided. The system can comprise a memory that can store computer executable components. The system can also comprise a processor, operably coupled to the memory, and that can execute the computer executable components stored in the memory. The computer executable components can comprise an assessment component that can assess a similarity metric between a source data set and a sample data set from a target machine learning task. The computer executable components can also comprise an identification component that can identify a pre-trained neural network model associated with the source data set based on the similarity metric to perform the target machine learning task.

According to an embodiment, a computer-implemented method is provided. The computer-implemented method can comprise assessing, by a system operatively coupled to a processor, a similarity metric between a source data set and a sample data set from a target machine learning task. Also, the computer-implemented method can comprise identifying, by the system, a pre-trained neural network model associated with the source data set based on the similarity metric to perform the target machine learning task.

According to an embodiment, a computer program product that can facilitate using a pre-trained neural network model to enhance performance of a target machine learning task is provided. The computer program product can comprise a computer readable storage medium having program instructions embodied therewith. The program instructions can be executable by a processor to cause the processor to assess, by a system operatively coupled to the processor, a similarity metric between a source data set and a sample data set from the target machine learning task. Also, the program instructions can further cause the processor to identify, by the system, the pre-trained neural network model associated with the source data set based on the similarity metric to perform the target machine learning task.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 illustrates a block diagram of an example, non-limiting system that can facilitate the selection of one or more pre-trained neural network models for transfer learning that can enhance the performance of one or more machine learning tasks in accordance with one or more embodiments described herein.

FIG. 2 illustrates a block diagram of an example, non-limiting system that can facilitate the selection of one or more pre-trained neural network models for transfer learning that can enhance the performance of one or more machine learning tasks in accordance with one or more embodiments described herein.

FIG. 3 illustrates a diagram of an example, non-limiting neural architecture that can be utilized by a system to facilitate the selection of one or more pre-trained neural network models for transfer learning, which can enhance the performance of one or more machine learning tasks in accordance with one or more embodiments described herein.

FIG. 4A illustrates a diagram of an example, non-limiting graph that can depict how the selection of a transfer model can affect the performance of a machine learning task in accordance with one or more embodiments described herein.

FIG. 4B illustrates a diagram of an example, non-limiting graph that can depict one or more predictions regarding performance enhancement of a machine learning task, wherein the one or more predictions can be generated by a system, which can facilitate the selection of one or more pre-trained neural network models for transfer learning regarding the machine learning task, in accordance with one or more embodiments described herein.

FIG. 5 illustrates a diagram of an example, non-limiting chart that can depict one or more similarity metrics that can be generated by a system to facilitate the selection of one or more pre-trained neural network models for transfer learning that can enhance the performance of one or more machine learning tasks in accordance with one or more embodiments described herein.

FIG. 6 illustrates a diagram of an example, non-limiting graph that can represent a visualization that can be generated by a system to facilitate the selection of one or more pre-trained neural network models for transfer learning that can enhance the performance of one or more machine learning tasks in accordance with one or more embodiments described herein.

FIG. 7A illustrates a diagram of an example, non-limiting graph that can depict transfer learning performance predictions that can be generated by a system to facilitate the selection of one or more pre-trained neural network models for transfer learning to enhance the performance of one or more machine learning tasks in accordance with one or more embodiments described herein.

FIG. 7B illustrates a diagram of an example, non-limiting graph that can depict transfer learning performance predictions that can be generated by a system to facilitate the selection of one or more pre-trained neural network models for transfer learning to enhance the performance of one or more machine learning tasks in accordance with one or more embodiments described herein.

FIG. 7C illustrates a diagram of an example, non-limiting graph that can depict transfer learning performance predictions that can be generated by a system to facilitate the selection of one or more pre-trained neural network models for transfer learning to enhance the performance of one or more machine learning tasks in accordance with one or more embodiments described herein.

FIG. 8 illustrates a diagram of an example, non-limiting graph that can depict transfer learning performance predictions that can be generated by a system to facilitate the selection of one or more pre-trained neural network models for transfer learning to enhance the performance of one or more machine learning tasks in accordance with one or more embodiments described herein.

FIG. 9 illustrates a diagram of an example, non-limiting pie chart that can depict a distribution of vision custom learning workloads in accordance with one or more embodiments described herein.

FIG. 10 illustrates a flow diagram of an example, non-limiting method that can facilitate selecting of one or more pre-trained neural network models for transfer learning that can enhance the performance of one or more machine learning tasks in accordance with one or more embodiments described herein.

FIG. 11 illustrates a flow diagram of an example, non-limiting method that can facilitate selecting of one or more pre-trained neural network models for transfer learning that can enhance the performance of one or more machine learning tasks in accordance with one or more embodiments described herein.

FIG. 12 depicts a cloud computing environment in accordance with one or more embodiments described herein.

FIG. 13 depicts abstraction model layers in accordance with one or more embodiments described herein.

FIG. 14 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Various artificial intelligence (“AI”) technologies utilize deep learning neural network models to perform one or more machine learning tasks. The accuracy of the models relies upon the amount and/or type of data used to train the models. For example, the more unique data (e.g., non-duplicate data) used to train a subject model, the more accurate the subject model can become. Yet, many machine learning tasks have a limited amount of data available to train the models. Additionally, wherein large amounts of data are available, training the models can be time consuming. Traditional approaches attempt to resolve these problems through transfer learning, wherein a pre-existing, pre-trained model is utilized to analyze a new data set and perform the one or more desired machine learning tasks. However, for a given new data set, the identification of which pre-trained model to select for transfer learning can directly affect the performance of the one or more desired machine learning tasks.

Various embodiments of the present invention can be directed to computer processing systems, computer-implemented methods, apparatus and/or computer program products that facilitate the efficient, effective, and autonomous (e.g., without direct human guidance) identification, creation, and/or selection one or more pre-trained neural network models for transfer learning to enhance the performance of one or more target machine learning tasks. One or more embodiments can regard comparing one or more source data sets of one or more pre-trained neural network models and one or more target data sets associated with one or more target machine learning tasks to assess one or more similarity metrics. Also, one or more embodiments can regard identifying which of the one or more pre-trained neural network models can most greatly enhance the performance of the one or more target machine learning tasks based on the one or more similarity metrics. In one or more embodiments, the one or more predefined neural network models can be identified from a library of models, and/or various embodiments can regard generating the one or more pre-trained neural network models from one or more features of one or more pre-existing models. Further, one or more embodiments can comprise autonomously selecting the one or more identified pre-defined neural network models and/or autonomously performing the one or more target machine learning tasks using the one or more identified and/or selected neural network models.

The computer processing systems, computer-implemented methods, apparatus and/or computer program products employ hardware and/or software to solve problems that are highly technical in nature (e.g., identifying, creating, and/or selecting one or more pre-trained neural network models for transfer learning to enhance the performance of one or more target machine learning tasks), that are not abstract and cannot be performed as a set of mental acts by a human. For example, an individual, or even a plurality of individuals, cannot readily and efficiently analyze the potential affects to performance that various pre-trained neural network models can have on a given machine learning task subject to transfer learning. Additionally, one or more embodiments described herein can utilize AI technologies that are autonomous in their nature to facilitate determinations and/or predictions that cannot be readily performed by a human.

As used herein, the term “machine learning task” can refer to an application of AI technologies to automatically and/or autonomously learn and/or improve from an experience (e.g., training data) without explicit programming of the lesson learned and/or improved. For example, machine learning tasks can utilize one or more algorithms to facilitate supervised and/or unsupervised learning to perform tasks such as classification, regression, and/or clustering.

As used herein, the term “neural network model” can refer to a computer model that can be used to facilitate one or more machine learning tasks, wherein the computer model can simulate a number of interconnected processing units that can resemble abstract versions of neurons. For example, the processing units can be arranged in a plurality of layers (e.g., one or more input layers, one or more hidden layers, and/or one or more output layers) connected with by varying connection strengths (e.g., which can be commonly referred to within the art as “weights”). Neural network models can learn through training, wherein data with known outcomes is inputted into the computer model, outputs regarding the data are compared to the known outcomes, and/or the weights of the computer model are autonomous adjusted based on the comparison to replicate the known outcomes. As used herein, the term “training data” can refer to data and/or data sets used to train one or more neural network models. As a neural network model trains (e.g., utilizes more training data), the computer model can become increasingly accurate; thus, trained neural network models can accurately analyze data with unknown outcomes, based on lessons learning from training data, to facilitate one or more machine learning tasks. Example neural network models can include, but are not limited to: perceptron (“P”), feed forward (“FF”), radial basis network (“RBF”), deep feed forward (“DFF”), recurrent neural network (“RNN”), long/short term memory (“LSTM”), gated recurrent unit (“GRU”), auto encoder (“AE”), variational AE (“VAE”), denoising AE (“DAE”), sparse AE (“SAE”), markov chain (“MC”), Hopfield network (“HN”), Boltzmann machine (“BM”), deep belief network (“DBN”), deep convolutional network (“DCN”), convolutional neural network (“CNN”), deconvolutional network (“DN”), deep convolutional inverse graphics network (“DCIGN”), generative adversarial network (“GAN”), liquid state machining (“LSM”), extreme learning machine (“ELM”), echo state network (“ESN”), deep residual network (“DRN”), kohonen network (“KN”), support vector machine (“SVM”), and/or neural turing machine (“NTM”).

As used herein, the term “transfer model” can refer to one or more neural network models that are pre-trained and can be utilized in one or more transfer learning processes, wherein new data sets can be analyzed by one or more transfer models to perform one or more machine learning tasks. Transfer models can be pre-existing models chosen from a library of neural network models and/or can be generated. For example, a transfer model can be generated from the combination and/or alteration of one or more pre-existing, pre-trained neural network models. Additionally, a transfer model can comprise a pre-trained neural network model that is fine-tuned based on one or more characteristics of the new data to be analyzed by the one or more subject machine learning tasks.

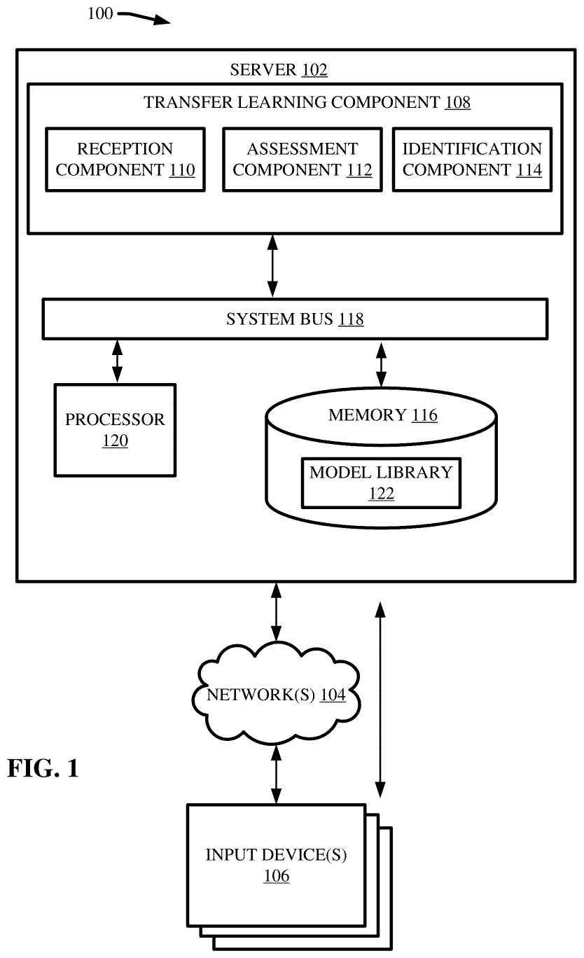

FIG. 1 illustrates a block diagram of an example, non-limiting system 100 that can identify and/or select one or more pre-trained transfer models to enhance the performance of one or more machine learning tasks in accordance with one or more embodiments described herein. Repetitive description of like elements employed in other embodiments described herein is omitted for sake of brevity. Aspects of systems (e.g., system 100 and the like), apparatuses or processes in various embodiments of the present invention can constitute one or more machine-executable components embodied within one or more machines, e.g., embodied in one or more computer readable mediums (or media) associated with one or more machines. Such components, when executed by the one or more machines, e.g., computers, computing devices, virtual machines, etc. can cause the machines to perform the operations described.

As shown in FIG. 1, the system 100 can comprise one or more servers 102, one or more networks 104, and/or one or more input devices 106. The server 102 can comprise transfer learning component 108. The transfer learning component 108 can further comprise reception component 110, assessment component 112, and/or identification component 114. Also, the server 102 can comprise or otherwise be associated with at least one memory 116. The server 102 can further comprise a system bus 118 that can couple to various components such as, but not limited to, the transfer learning component 108 and associated components, memory 116 and/or a processor 120. While a server 102 is illustrated in FIG. 1, in other embodiments, multiple devices of various types can be associated with or comprise the features shown in FIG. 1. Further, the server 102 can communicate with a cloud computing environment via the one or more networks 104.

The one or more networks 104 can comprise wired and wireless networks, including, but not limited to, a cellular network, a wide area network (WAN) (e.g., the Internet) or a local area network (LAN). For example, the server 102 can communicate with the one or more input devices 106 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the transfer learning component 108 can be provided on the one or more servers 102, it should be appreciated that the architecture of system 100 is not so limited. For example, the transfer learning component 108, or one or more components of transfer learning component 108, can be located at another computer device, such as another server device, a client device, etc.

The one or more input devices 106 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. A user of the system 100 can utilize the one or more input devices 106 to input data into the system 100, thereby sharing (e.g., via a direct connection and/or via the one or more networks 104) said data with the server 102. For example, the one or more input devices 106 can send data to the reception component 110 (e.g., via a direct connection and/or via the one or more networks 104). Additionally, the one or more input devices 106 can comprise one or more displays that can present one or more outputs generated by the system 100 to a user. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

A user of the system 100 can utilize the one or more input devices 106 and/or the one or more networks 104 to input one or more target data sets into the system 100. The one or more target data sets can comprise unknown distributions of data to be analyzed by one or more target machine learning tasks. The target data sets can comprise data of various types, which can represent information in one or more forms of media. For example, the target data set can comprise data representing, but not limited to: images (e.g., photos, maps, drawings, paintings, and/or the like), text (e.g., messages, books, literature, signs, encyclopedias, dictionaries, thesauruses, contracts, laws, constitutions, scripts, and/or the like), videos (e.g., video segments, movies, plays, and/or the like), audio recordings, audio signals, labels, speech, conversations, people, sports, tools, fruits, fabrics, buildings, furniture, garments, music, nature, plants, trees, fugus, foods, animals, knowledge bases, a combination thereof, and/or like. One of ordinary skill in the art will readily recognize that the target data set can comprise any type of computer data and can represent a variety of topics. Thus, the various embodiments described herein are not limited to the analysis of a particular type and/or source of data. In one or more embodiments, the one or more input devices 106 can facilitate inputting the target data sets via one or more interfaces (e.g., an application programming interface and/or an Internet interface) and/or cloud computing environments.

In one or more embodiments, the transfer learning component 108 can analyze the one or more target data sets to identify one or more pre-trained neural network models that can serve as transfer models to enhance the performance of one or more target machine learning tasks. Additionally, in one or more embodiments, the transfer learning component 108 can analyze the one or more target data sets to generate one or more transfer models from pre-trained neural network models to enhance the performance of one or more target machine learning tasks. Further, in various embodiments, the transfer learning component 108 can facilitate the selection of one or more identified and/or generated transfer models to perform the one or more target machine learning tasks.

The reception component 110 can receive the data entered by a user of the system 100 via the one or more input devices 106. The reception component 110 can be operatively coupled to the one or more input devices 106 directly (e.g., via an electrical connection) or indirectly (e.g., via the one or more networks 104). Additionally, the reception component 110 can be operatively coupled to one or more components of the server 102 (e.g., one or more component associated with the transfer learning component 108, system bus 118, processor 120, and/or memory 116) directly (e.g., via an electrical connection) or indirectly (e.g., via the one or more networks 104). In one or more embodiments, the one or more target data sets received by the reception component 110 can be communicated to the assessment component 112 (e.g., directly or indirectly) and/or can be stored in the memory 116 (e.g., located on the server 102 and/or within a cloud computing environment).

The assessment component 112 can extract one or more sample data sets from the one or more target data sets. Further, the assessment component 112 can pass the one or more sample data sets in a forward pass through one or more pre-trained neural network models. The one or more pre-trained neural network models can be, for example, comprised within a library of models 122, wherein the library of models 122 can be stored in the memory 116 and/or a cloud computing environment (e.g., accessible via the one or more networks 104). Thereby, the one or more pre-trained neural network models can generate respective feature descriptors (e.g., feature vectors) characterizing the one or more sample data sets. For example, the one or more respective feature descriptors can be outputted by one or more layers of the respective pre-trained neural network models. In one or more embodiments, the assessment component 112 can use a feature extractor to extract the one or more feature descriptors to compute a target feature representation.

Further, the one or more respective pre-trained neural network models can generate respective feature descriptors (e.g., feature vectors) characterizing one or more source data sets. As used herein, the term “source data set” can refer to a data set used to train a subject neural network model. The one or more respective feature descriptors can be outputs from one or more layers of the respective pre-trained neural network model regarding the one or more source data sets. In one or more embodiments, the assessment component 112 can use a feature extractor to extract the one or more feature descriptors that can characterize the one or more source data sets. Further, the assessment component 112 can aggregate a plurality of feature descriptors that characterize the source data sets using one or more statistical aggregation techniques (e.g., averaging, utilization of code books, standard deviation, median average, and/or the like). For example, the assessment component 112 can extract one or more outputs of one or more layers of a pre-trained neural network model as feature descriptors. Further, for a respective category comprising the pre-trained neural network model, the assessment component 112 can average the feature descriptors characterizing source data sets within the respective category to compute a category feature representation. For instance, the assessment component 112 can use a pre-trained neural network model's (e.g., a CNN) layer's (e.g., any one or more layers comprising the CNN, such as a penultimate layer) output as feature vectors and compute each category's average feature vectors as the category feature representation.

Thus, the assessment component 112 can perform a feature extraction to compute one or more target feature representations and/or one or more source feature representations regarding each respective pre-trained neural network model assessed. The one or more target feature representations can characterize the one or more sample data sets with respect to a given pre-trained neural network model. The one or more source feature representations can characterize the one or more source data sets with respect to the given pre-trained neural network model. Further, the one or more target feature representations and/or the one or more source feature representation can be computed from a variety of feature spaces and/or levels in the respective pre-trained neural network models.

Additionally, the assessment component 112 can assess one or more similarity metrics between the one or more target feature representations and the one or more source feature representations. For example, the assessment component 112 can utilize one or more distance computation techniques to assess the similarity and/or dissimilarity between the one or more target feature representations and/or the one or more source feature representations. Example distance computation techniques can include, but are not limited to: Kullback-Leibler divergence (“KL-divergence”), Euclidean distance (“L2 distance”), cosine similarity, Manhattan distance, Minkowski distance, Jaccard similarity, Jensen Shannon distance, chi-square distance, a combination thereof, and/or the like. One of ordinary skill in the art will recognize that a plethora of distance computation techniques can be suitable with the various embodiments described herein. Thus, the one or more similarity metrics can indicate how similar and/or dissimilar the one or more sample data sets, and thereby the target data sets, are from the one or more source data sets. For example, the one or more similarity metrics can compare the one or more sample data sets and/or the one or more source data sets at different feature spaces and/or at different levels in a respective pre-trained neural network model. For instance, the one or more similarity metrics can compare the one or more sample data sets and/or the one or more source data sets at a category level and/or a label level. The one or more similarity metrics can be stored in the memory 116 (e.g., located on the server 102 and/or a cloud computing environment accessible via the one or more networks 104).

The identification component 114 can compare the similarity metrics regarding assessed pre-trained network models to identify which of the assessed pre-trained network models best fits the one or more target data sets, and thereby provides the greatest enhancement to the target machine learning task. For example, wherein the assessment component 112 assess the library of models 122 (e.g., computing similarity metrics for one or more pre-trained neural network models comprised within the library of models 122), the identification component 114 can identify one or more pre-trained neural network models comprised within the library of models 122 based on the assessed similarity metrics. In one or more embodiments, the identification component 114 can identify one or more assessed pre-trained neural network models that can have the closest correlation, based on the similarity metrics, to the target data set, as compared to other assessed pre-trained neural network models. Thus, the identification component 114 can identify, based on the assessed similarity metrics, one or more pre-trained neural network models that could best serve as transfer models to analyze the one or more target data sets and enhance the performance of the one or more target machine learning tasks.

In one or more embodiments, the identification component 114 can identify one or more pre-trained neural network models from the library of models 122 to serve as one or more transfer models based on the similarity metrics and a similarity threshold. For example, the identification component 114 can identify one or more pre-trained neural network models based on a comparison of the similarity metrics with each other and with the similarity threshold. The similarity threshold can be defined by a user of the system 100 (e.g., via the one or more input devices 106 and/or networks 104) and can represent a minimal metric that must be met by a respective similarity metric to qualify the associated pre-trained neural network model for identification.

In various embodiments, the identification component 114 can generate one or more new pre-trained neural network models from a plurality of existing pre-trained neural network models. For example, wherein none of the assessed pre-trained neural network models are characterized by a similarity metric greater than the similarity threshold, two or more of the assessed pre-trained neural network models (e.g., those most similar to the one or more target data sets based on the similarity metrics) can be used to generate a new pre-trained neural network model. To generate the one or more new pre-trained neural network models the identification component 114 can compose a neural network model as a mixture of different layers extracted from each of the plurality of pre-existing, pre-trained neural network models. Different layers of respective pre-trained neural network models can have different similarity metrics; thus, the identification component 114 can mix one or more first layers of a first pre-trained neural network model that are most similar to the one or more target data sets (e.g., as characterized by the similarity metrics) with one or more second layers of a second pre-trained neural network model that are most similar to the one or more target data sets (e.g., as characterized by the similarity metrics). Said mixture of the one or more first layers and the one or more second layers can comprise re-weighting one or more feature vectors to construct the new pre-trained neural network model. The resulting composition of mixed first layers and second layers can be more similar, based on the similarity metrics, to the one or more target data sets than the pre-existing, pre-trained neural network models from which the first and second layers originated. For instance, the identification component 114 can combine one or more food features from a pre-trained food neural network model with one or more animal learned labels to create a new pre-trained pet food neural network model. The identification component 114 can further identify the new pre-trained neural network model as a preferred transfer model for the one or more target machine learning tasks.

In one or more embodiments, the identification component 114 can merge one or more pre-existing neural network models of different domains to generate the one or more new pre-trained neural network models. For example, one or more knowledge-based pre-trained neural network models can be merged (e.g., by the identification component 114) with one or more vision-based pre-trained neural network models to generate one or more new hybrid pre-trained neural network models. For instance, one or more images comprised within a vision-based pre-trained neural network model can have one or more associated knowledge labels not described by the vision-based pre-trained neural network model. Said knowledge labels can be used to perform an analysis process in a knowledge-based pre-trained neural network model. Respective data streams from the vision-based pre-trained neural network model layers and the knowledge-based pre-trained neural network model can be merged within a single layer (e.g., a single soft-max layer) to produce a multi-modal output.

In one or more embodiments, the identification component 114 can generate one or more charts, diagrams, and/or graphs depicting the one or more similarity metrics and/or the one or more identified pre-trained neural network models (e.g., a pre-existing, pre-trained neural network model or a generated new pre-trained neural network model). The generated charts, diagrams, and/or graphs can be presented (e.g., displayed) to a user of the system 100 (e.g., via the one or more input devices 106 and/or one or more networks 104) to facilitate the user's selection of one or more pre-trained neural network models for transfer learning. In one or more embodiments, the identification component 114 can autonomously select the one or more identified pre-trained neural network models (e.g., a pre-existing, pre-trained neural network model or a generated new pre-trained neural network model) to serve as one or more transfer models to enhance the performance of one or more target machine learning tasks. Further, the identification component 114 can present (e.g., display) to a user of the system 100 (e.g., via the one or more input devices 106 and/or one or more networks 104) the one or more generated charts, diagrams, and/or graphs as an explanation of the autonomous selection.

Furthermore, in various embodiments, the identification component 114 can perform one or more data processing steps, which can, for example, fine-tune one or more of the identified pre-trained neural network models. Example processing steps can include, but are not limited to: data normalization, data rotation, data scaling, a combination thereof, and/or like.

Thus, the transfer learning component 108 can estimate the performance change a particular source data set used to learn initial weights for transfer to a target data set would impart in comparison to training from other source data sets and/or randomly initialized weights. For example, in one or more embodiments the transfer learning component 108 can iterate over all possible transfer scenarios “M(tᵢ, sⱼ)” on a collection of one or more sample data sets and source data sets. For each pair of one or more target data sets and/or source data sets “(tᵢ, sⱼ),” performance improvement (e.g., increased accuracy) gained by transfer in each scenario can be measured in accordance to Equation 1 below.

I(tᵢ,sⱼ)=P(M(tᵢ,sⱼ))−P(M(tᵢ,ϕ)) (1)

Wherein “P( )” can define the performance evaluation (e.g., accuracy), “ϕ” can represent the nil data set (e.g., randomly initialized weights), and “I(tᵢ, sⱼ)” can be the measured performance improvement of transfer from the source data set “sⱼ” to the target data set “tᵢ.” Selecting the optimal source data set can then be characterized by Equation 2 below, wherein “S” can represent the optimal source data set.

θ(tᵢ,S)=argmaxₛ_{ⱼ}I(tᵢ,sⱼ) (2)

Additionally, the transfer learning component 108 can utilize, for example, Equations 3-5, presented below, in accordance with the various feature extractions, aggregations, and/or assessments described herein.

E(tᵢ,sᵢ)∝1 (3)

θ(tᵢ,S)=argmaxₛ_{ⱼ}E(tᵢ,sⱼ) (4)

E(tᵢ,sⱼ)=D[A(F(tᵢ)),A(F(sⱼ))] (5)

Wherein “D( )” can be a distance measure, and “A( )” can be a statistical aggregation technique to combine sets of individual data instance “F( )” into vectors representing the entire subject data set. For example, “F(tᵢ)” can be a set of feature vectors over images contained in the target data set, and “A(F(tᵢ))” can be the average over those feature vectors. As another example, “F(tᵢ)” can be a set of scale-invariant feature transform (“SIFT”) features over images in the target data set, and “A(F(tᵢ))” can correspond to a codebook histogram.

For example, the transfer learning component 108 can take “F(tᵢ)” as the output of the penultimate layer of a neural network model, and can take “A(F(tᵢ))” as the average in accordance with Equation 6 below.

$$A ( F ( {t}_{i} ) ) = \frac{1}{N} {\sum }_{k = 0}^{N} f ( {t}_{ik} ) \qquad ( 6 )$$

Wherein “tᵢk” can be the k^{th} data (e.g., image) of the target data set, “f ( )” can be the feature embedding function, and “N” can be the number of samples in the subject data set.

Regarding “D( )”, the transfer learning component 108 (e.g., via assessment component 112) can compute one or more variations that can be designed empirically and/or can consider both data set size as well as statistical differences in the data sets using one or more distance computation techniques (e.g., KL-divergence, L2 distance, cosine similarity, Manhattan distance, Minkowski distance, Jaccard similarity, Jensen Shannon distance, a combination thereof, and/or the like). For example, “DO” can be computed in accordance with Equation 7 below.

$$D ( t , s ) = ( 1 - \frac{1}{1 + {e}^{- α kl ( KL ( t , s ) - μ kl ) / σ kl}} ) \cdot ( \frac{1}{1 + {e}^{- {α}_{s} ( \vert s \vert - {μ}_{s} ) / {σ}_{s}}} ) \qquad ( 7 )$$

Wherein “(μ_{kl,s},σ_{kl,s})” can be the mean and standard deviations of the KL divergences or other distance computational technique, and the source data set size, and “α_{kl,s}” can be learned parameters that can change how quickly each term reaches saturation.

Similarity and/or data set size can be aspects that affect resulting transfer performance, and the influence of each can be well-approximated by a sigmoid, wherein the sigmoid can reflect the non-linear nature of each term and/or enforce that the scale of both aspects can be controlled and/or mathematically well-behaved. For example, in Equation 7, the first term can regard the similarity aspect and the second term can regard the source data set size aspect. One of ordinary skill in the art will recognize that while the above exemplary mathematics utilize an engineering design approach to an approximation function, the various embodiments described herein can be utilized to explicitly learn linear and/or non-linear functions to approximate “I”.

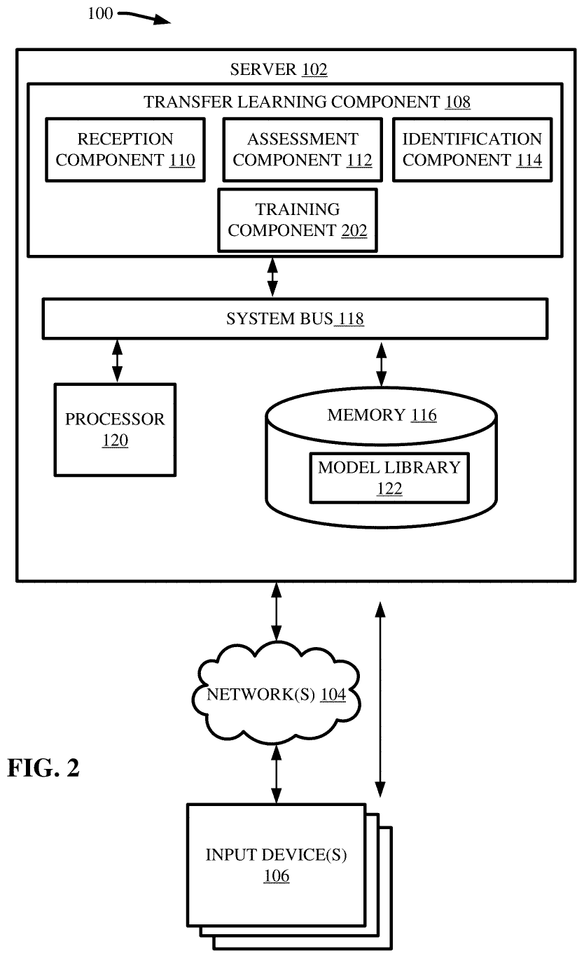

FIG. 2 illustrates a block diagram of the example, non-limiting system 100 further comprising a training component 202 in accordance with one or more embodiments described herein. Repetitive description of like elements employed in other embodiments described herein is omitted for sake of brevity.

Once an identified pre-trained neural network model (e.g., a pre-existing, pre-trained neural network model or a generated pre-trained neural network model) is selected (e.g., either through autonomous selection of one or more identified pre-trained neural network models or through user selection of one or more identified pre-trained neural network models), the training component 202 can perform a final training pass using the one or more target data sets on the selected pre-trained neural network model. In one or more embodiments, the training component 202 can autonomously perform the one or more target machine learning tasks using the one or more target data sets and/or the selected transfer model (e.g., identified pre-trained neural network model).

In one or more embodiments, with regards to a vision machine learning task the transfer learning component 108 (e.g., via assessment component 112) can use, for example, a VGG16 pre-trained neural network model as a feature extraction machine. The VGG16 pre-trained neural network model can comprise 5 blocks of convolutional layers followed by three full connection layers. The penultimate full connection layer, for example, can be used to extract features in the learnt space and/or a layer before the full connection layer to extract features in an image space. For example, give a domain with M(m₁, m₂, . . . mₖ) images, the assessment component 112 can generate feature vectors V(v₁, v₂, . . . vₖ) for each image in the domain by collecting output from the feature extractor machine. Further, the assessment component 112 can computer an average of the vectors to generate a raw average feature vector that can represent the feature of the subject domain. To compute KL-divergence, the assessment component 112 can apply L1-noramlization to the raw average vector and/or meanwhile add the raw average vector with epsilon=1e−12 for both the source data set and the target data set to avoid a divided by zero case.

In one or more embodiments, with regards to knowledge base population (“KBP”) machine learning tasks, the transfer learning component 108 can utilize, for example, the CC-DMP data set, the text of Common Crawl, and/or the knowledge schema and/or training data from DBpedia. DBpedia is a knowledge graph extracted from infoboxes from Wikipedia, wherein the fields of the inforboxes can be mapped into a knowledge schema. The knowledge schema can also comprise a hierarchy of relations and/or can group basic relations into more abstract, high level relations. An example is the hasMember/isMemberOf relation, which can group relations such as employer, bandmember, and/or (political) party.

An edge in the DBpedia knowledge graph can be, for example, <LARRY MCCRAY genre BLUES>, meaning Larry McCray is a blues musician. This relationship can be expressed through the DBpedia genre relation, a sub-relation of the high-level relation isClassifiedBy. The task of KBP can be to predict such relationships from the textual mentions of the arguments. For instance, the sole context connecting the two arguments can be, for example, the sentence “If you're in the mood for the blues, Larry McCray is the headliner Saturday.”

Additionally, the relations between two nodes in the knowledge graph can be predicted from the entire set of textual evidence, rather than each sentence separately. For example, CARIBOU COFFEE and MINNESOTA can be connected by the location relation, a fact strongly indicated by the contexts in which they co-occur, shown below.
On both sides of the entrance were Caribou Coffee shops, the Minnesota version of Starbucks.
Plenty of other Minnesota-based brands, ranging from 3M to Caribou Coffee, attempted to pay tribute to Prince, a Minneapolis native.

For example, the transfer learning component 108 can split the knowledge base population into a number of subtasks (e.g., seven) of populating common high-level relations, with relations outside those subtasks ignored. For instance, the transfer learning component 108 can use the DBpedia relation taxonomy, taking the number (e.g., seven) of high-level relations with the most positive examples in CC-DBP, which can be analogous to the split of ImageNet by high-level class.

The transfer learning component 108 (e.g., via the assessment component 112 and/or the identification component 114) can further measure to what degree the subtasks permit transfer learning. For instance, a deep neural network model can be trained on the source domain, then fine-tuned on the target domain. Fine-tuning can involve re-initializing the final layer to random. Further, the final layer can also be a different shape, since the different domains can have different numbers of relations. The final layer can be updated at the full learn rate “α” while the previous layers can be updated at f·α(f<1), wherein a fine-tune multiplier of, for example, f=0.1 can be utilized. Feature representations can be taken from, for example, the penultimate layer and/or the max-pooled network-in-network.

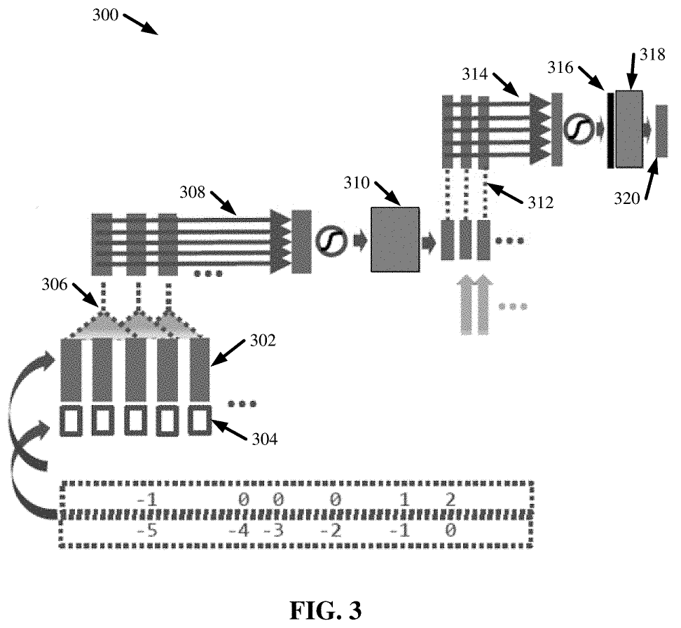

For example, FIG. 3 illustrates a diagram of an example, non-limiting neural architecture 300 that can be utilized by the system 100 for binary relation extraction in accordance with one or more embodiments described herein. Repetitive description of like elements employed in other embodiments described herein is omitted for sake of brevity. As shown in FIG. 3, the exemplary neural architecture 300 can comprise word vectors 302 (e.g., which can be pre-trained by word2vec), position embeddings 304 (e.g., which can encode the distance of each word to each argument), CNN 306 (e.g., which can be applied over each sentence representation), piecewise max-pooling 308 (e.g., which can max-pool the CNN 306 output for each segment of the sentence: before the first argument, between the arguments, and after the last argument), a first fully connected layer 310 (e.g., which can produce the final sentence vector representation), network-in-network 312 (e.g., which can aggregate over the sentence vectors using width-1 CNN), simple max-pool 314 (e.g., which can gather the aggregation to a fixed length vector), vector representations 316 (e.g., for a context set used for vector averaging and/or distance between domain computations), a second fully connected layer 318 (e.g., which can transform the context set representation into predictions for each relation), and/or relation predictions 320 (e.g., which can give the probability for each relation. Further, Table 1, presented below, can depict hyperparameters that can be used in the neural architecture 300.

TABLE 1

| Hyperparameter | Value |
|---|---|
| Word embedding | 50 |
| Position embedding | 5 |
| Sentence vector | 400 |
| Network-in-network | 400 |
| filters | |
| CNN filters | 1000 |
| CNN filter width | 3 |
| Dropout | 0.5 |

To demonstrate the efficacy of the various embodiments described herein, the system 100 was utilized to analyze vision-based neural network models and/or source data sets, such as the database ImageNet22k, which contains 14 million images spread over 1481 categories. These categories fall into a few hierarchies like animals, buildings, fabric, food, fruits, fungus, furniture, garment, musical, nature, person, plant, sport, tool, and/or vehicles. To demonstrate the efficacy of the system 100, ImageNet22k was partitioned along these hierarchies to form multiple source data sets and/or target data sets. Each of these data sets was further split into 4 parts: a first part was used to train the source model, a second part was used for validating the source model, a third part as used to create a transfer learning target workload, and a fourth part was used for validating the transfer learning training. For example, the person hierarchy has greater than 1 million images, which were split into 4 equal partitions of greater than 250 thousand each. The source model was trained with data of that size and the target model was trained with one tenth of that data size.

Thus, 15 source workloads and/or 15 target training workloads were generated, which were then grouped into two groups. A first group, consisting of sport, garment, plant and animal, was used to generate one or more parameters for Equation 7 and also to determine which distance computation technique provided the closest prediction to ground truth. The second group, consisting of food, person, nature, music, fruit, fabric, and building, was used to validate said parameters. Further, the training of the source and target models was performed on caffe using a ResNet27 neural network model. The source models were trained using stochastic gradient descent (“SGD”) for 900,000 iterations with a step size of 300,000 iterations and an initial learning rate of 0.01. The target models were trained on the same neural network model using SGD for one tenth of the iteration and step size. To ensure determinism, the training was done using a random seed of 1337.

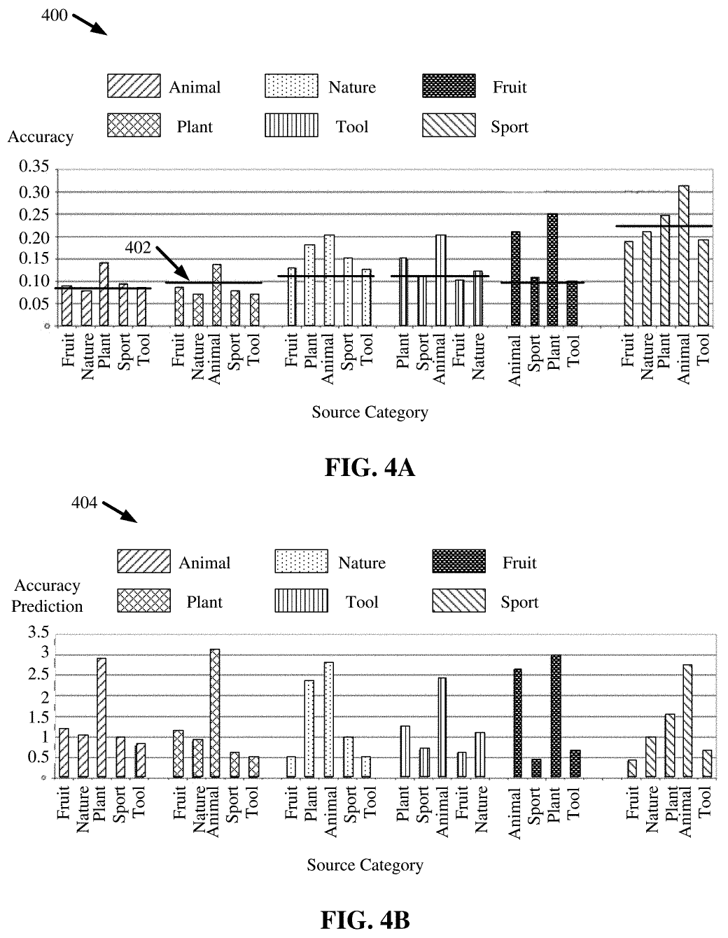

FIG. 4A illustrates a diagram of an example, non-limiting chart 400 that can depict how selection of a transfer model can affect the performance of one or more target machine learning tasks in accordance with one or more embodiments described herein. Repetitive description of like elements employed in other embodiments described herein is omitted for sake of brevity. The bars depicted in chart 400 present the level of accuracy associated a particular target data set (e.g., an animal target data set, a plant target data set, a nature target data set, a tool target data set, a fruit target data set, and/or a sport target data set) analyzed with a neural network model pre-trained with a particular source data set (e.g., an animal source data set, a plant source data set, a nature source data set, a tool source data set, a fruit source data set, and/or a sport source data set).

For example, the first bar, from left to right, represents the level of accuracy associated with an animal target data set analyzed using a neural network model pre-trained using a fruit source data set. The second bar, from left to right, represents the level of accuracy associated with an animal target data set analyzed using a neural network model pre-trained using a nature source data set. The sixth bar, from left to right, represents the level of accuracy associated with a plant target data set analyzed using a neural network model pre-trained using a fruit source data set. The line 402 represents the level of accuracy associated with the target data sets analyzed on a neural network model that was not pre-trained.

As shown by chart 400, the use of a transfer model does not always enhance the performance (e.g., the accuracy) of a machine learning task. For example, analyzing the plant target data set on a neural network model pre-trained using a fruit source data set can result in a level of accuracy that is less than the level of accuracy that would have otherwise resulted from analyzing the plant target data set on a non-trained neural network model (e.g., as represented by line 402). However, in other instances, the use of a transfer model can result in a substance enhancement in the performance (e.g., accuracy) of a machine learning task. For example, analyzing the plant target data set on a neural network model pre-trained using an animal source data set can result in a level of accuracy that is greater than the level of accuracy that would have otherwise resulted from analyzing the plant target data set on a non-trained neural network model (e.g., as represented by line 402).

In various embodiments, the system 100 can facilitate the identification and/or selection of one or more pre-trained neural network models (e.g., pre-existing, pre-trained neural network models or generated pre-trained neural network models) to serve as transfer models that can enhance the performance (e.g., the accuracy) of the one or more target machine learning tasks. In other words, the system 100 can facilitate a user in identifying and/or selecting transfer models that will enhance performance characteristics and/or avoid the use of transfer models that will deteriorate performance characteristics. As shown in via chart 400, the system 100 (e.g., via the transfer learning component 108) can estimate the performance change a particular source data set used to learn initial weights for transfer to a target data set would impart in comparison to training from other source data sets and/or randomly initialized weights.

FIG. 4B illustrates a diagram of an example, non-limiting chart 404 that can depict one or more performance (e.g., accuracy) predictions, which can be generated by the system 100, regarding potential transfer model selections. Repetitive description of like elements employed in other embodiments described herein is omitted for sake of brevity. In one or more embodiments, the identification component 114 can generate exemplary chart 404 to facilitate the selection of a transfer model and/or elaborate upon the autonomous selection of a transfer model.

Chart 404 can regard the same target data sets and/or source data sets as those depicted in chart 400. For a given pre-trained neural network model, the identification component 114 can predict the level of performance (e.g., accuracy) associated with an analysis of a target data set. For example, of the five source data sets (e.g., the fruit source data set, the nature source data set, the plant source data set, the sport source data set, and/or the tool source data set) assessed by the transfer learning component 108 (e.g., via the assessment component 112) with regards to the animal target data set, the identification component 114 can predict, based on the assessed similarity metrics, that the neural network model trained on the plant source data set can result in the greatest enhancement in performance (e.g., accuracy) when used a transfer model. In other words, the identification component 114 can predict that the neural network model trained on the plant source data set can perform the target machine learning task with greater accuracy that the other assess pre-trained neural network models and/or an un-trained neural network model. A comparison of chart 400 and 404 illustrates that the predictions, and thereby identifications, made by the identification component 114 can be closely correlate to actual performance characteristics. Exemplary charts 400 and/or 404, and/or similar charts, can be presented (e.g., displayed) to one or more users of the system 100 via the one or more input devices 106 and/or one or more networks 104.

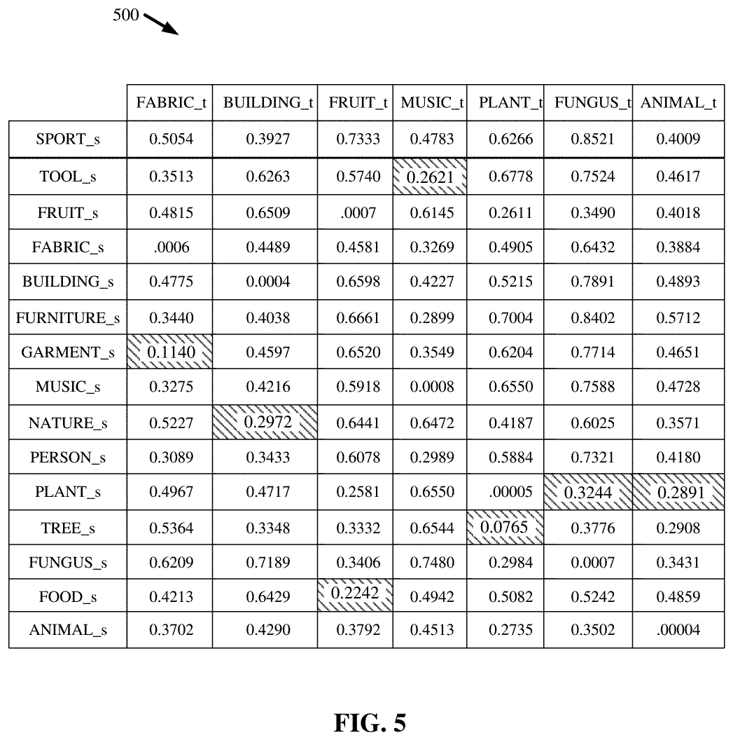

FIG. 5 illustrates a diagram of an example, non-limiting chart 500 that can depict similarity metrics, which can be assessed by the system 100 in accordance with one or more embodiments described herein. Repetitive description of like elements employed in other embodiments described herein is omitted for sake of brevity. Exemplary chart 500 can be generated, for example, by the identification component 114 to facilitate selection of one or more identified pre-trained neural network models (e.g., pre-existing, pre-trained neural network models or generated pre-trained neural network models) and/or elaborate upon the autonomous selection of an identified pre-trained neural network model. As shown in FIG. 5, the term “_t” can denote target data sets and the term “_s” can denote source data sets. The similarity metrics depicted in chart 500 can be computed using, for example, KL-divergence. Further, shaded cells of chart 500 can denote identification of a preferred pre-trained neural network model based on the similarity metrics associated with the assessed pre-trained neural network models. For example, the shaded cell in the “FABRIC_t” column of chart 500 can indicate that the identification component 114 identifies a neural network model pre-trained using the garment source data set as a preferred transfer model to analyze the fabric target source data set. Exemplary chart 500, and/or similar charts, can be presented (e.g., displayed) to one or more users of the system 100 via the one or more input devices 106 and/or one or more networks 104.

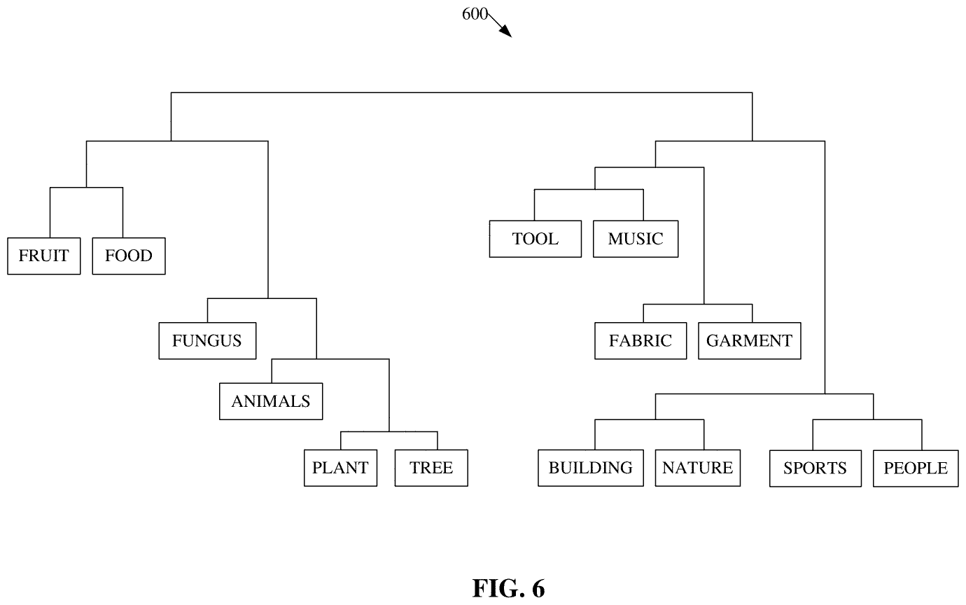

FIG. 6 illustrates a diagram of an example, non-limiting graph 600 that can provide a visual representation of the assessed similarity metrics and/or relations between target data sets and/or source data sets, in accordance with one or more embodiments described herein. Repetitive description of like elements employed in other embodiments described herein is omitted for sake of brevity. Exemplary graph 600 can be generated, for example, by the identification component 114 to facilitate selection of one or more identified pre-trained neural network models (e.g., pre-existing, pre-trained neural network models or generated pre-trained neural network models) and/or elaborate upon the autonomous selection of an identified pre-trained neural network model. Graph 600 can depict how one or more target data sets correlate to one or more source data sets based on the assessed similarity metrics. Exemplary graph 600, and/or similar graphs, can be presented (e.g., displayed) to one or more users of the system 100 via the one or more input devices 106 and/or one or more networks 104.

To further demonstrate the efficacy of the system 100, DBpedia was analyzed in accordance with one or more embodiments described herein. Table 2, presented below, shows seven source domains extracted from DBpedia.

TABLE 2

| Division Name | Number of Relations | Positives in Train |
|---|---|---|
| coparticipatesWith | 227 | 78598 |
| hasLocation | 85 | 72065 |
| sameSettingAs | 169 | 40359 |
| isClassifiedBy | 34 | 22743 |
| hasPart | 64 | 12319 |
| hasMember | 45 | 36706 |
| hasRole | 4 | 7320 |

A model was trained for the domains of Table 2 on the full training data for the relevant relation types. Further, a new small training set was built for each division to form the target domains. The training sets were built to contain approximately twenty positives for each relation type. For each task twenty positive examples were taken for each relation from the full training set or all the training example if there were fewer than twenty positive examples. Further, ten times as many negative examples were sampled.

The model trained from the full training data of each of the different subtasks was then fine-tuned on the target domain. The are under the precision/recall curve for each trained model was measured. Additionally, the area under the precision/recall curve for a model trained without transfer learning was measured. Moreover, the performance of the transfer learning model was divided by the performance of the trained model. Wherein computational resources are available to train multiple models transferred from different sources, an ensemble was constructed. To compute the prediction of the ensemble, the scores of the models were averaged.

For each of the seven target domains, there are six different source models to possibly transfer from. An ensemble of the three models predicted to have the worst performance was compared to an ensemble of the three models predicted to have the best performance. The transfer performances are presented in Table 3 below, which illustrates that an ensemble of all models results in the best performance, but given the constraint where only three models may be selected to train, using the three top predictions outperforms using the three bottom predictions.

TABLE 3

| | Best | | | |
|---|---|---|---|---|
| | Single | Full | Bottom | Top |
| Division Name | Model | Ensemble | Predictions | Predictions |
| coparticipatesWith | 0.6648 | 0.7039 | 0.6305 | 0.7161 |
| hasLocation | 0.7572 | 0.7906 | 0.7488 | 0.7822 |
| sameSettingAs | 0.6347 | 0.6488 | 0.5865 | 0.6597 |
| isClassifiedBy | 0.7472 | 0.8065 | 0.7712 | 0.7909 |
| hasPart | 0.7057 | 0.7574 | 0.7040 | 0.7396 |
| hasMember | 0.8549 | 0.8682 | 0.8067 | 0.8795 |
| hasRole | 0.8278 | 0.8728 | 0.8203 | 0.8676 |

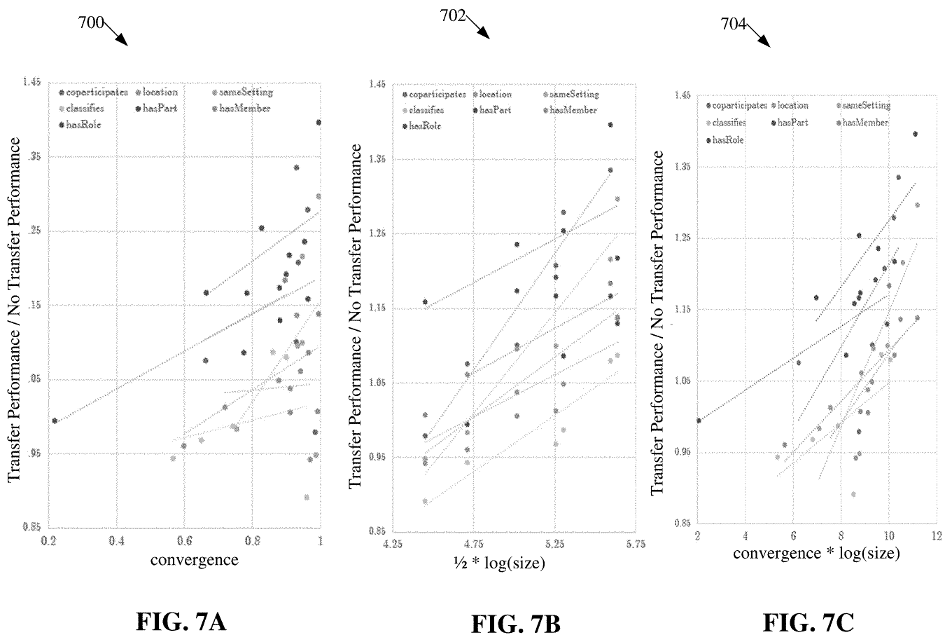

Additionally, FIG. 7A illustrates a diagram of an example, non-limiting graph 700, that can depict transfer learning improvement regarding the DBpedia analysis as based on one or more similarity metrics. Repetitive description of like elements employed in other embodiments described herein is omitted for sake of brevity. Further, FIG. 7B illustrates a diagram of an example, non-limiting graph 702, that can depict transfer learning improvement regarding the DBpedia analysis as based on size of the respective data sets. Repetitive description of like elements employed in other embodiments described herein is omitted for sake of brevity. Moreover, FIG. 7C illustrates a diagram of an example, non-limiting graph 706, that can depict transfer learning improvement regarding the DBpedia analysis as based on a combination of similarity aspects and/or size aspects. Repetitive description of like elements employed in other embodiments described herein is omitted for sake of brevity.

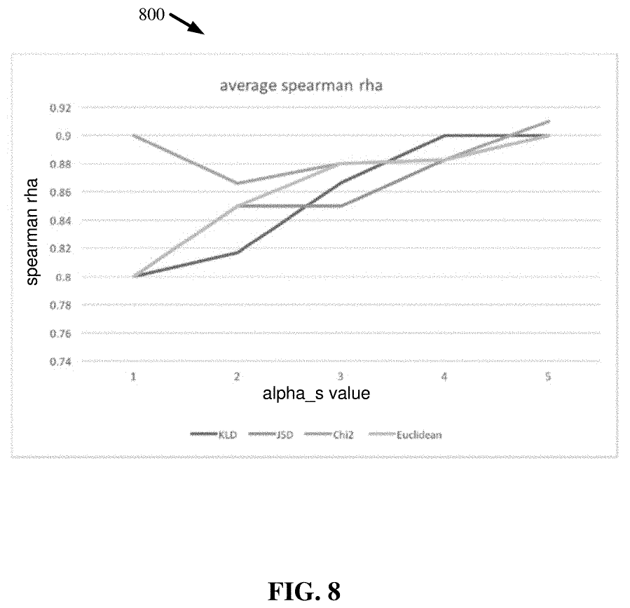

FIG. 8 illustrates a diagram of an example, non-limiting line graph 800 that can depict how various distance computation techniques can affect one or more assessments and/or determinations facilitated by the system 100 in accordance with the one or more embodiments described herein. Repetitive description of like elements employed in other embodiments described herein is omitted for sake of brevity.

In one or more embodiments, the distance measure can be inspired from KL divergences, Jenson Shannon distance, Euclidean distance, and/or chi square distance. To demonstrate the effectiveness of each distance separate measures were created based on each technique and named as MKL, MJS, ME, and MChi respectively. To determine which technique worked the best, for the training data sets, the prediction measure was calculated for accuracy of a give source data set and target data set. The prediction measures were then ranked by Spearmans Rank Correlation for a target. Then the top-1 ground truth accuracy obtained by the training of each of the target data sets from the various source data sets in the group was ranked. The top-1 accuracy was also ranked by Spearmans Rank Correlation for each target.

FIG. 8 illustrates the average Spearmans Rho of the top-1 ground truth rank and the predicted rank as they varied with various alpha values of Equation 7. As alpha increases it can amplify any noise and so it has been capped at 5. In this interval, MKL can be the most appropriate.

Furthermore, the accuracy of predictions and/or identification generated in accordance with one or more embodiments described herein has been validated on real machine learning jobs. Training data that had been submitted to a commercially available machine learning service was analyzed using the system 100 in accordance with the various embodiments described herein. For example, that accuracy of one or more predictions and/or identification generated based on the computations of Equation 7 was validated, wherein the one or more predictions and/or identifications regarded which neural network model form a collection of candidate neural network models would be the best starting point from which to facilitate transfer learning for a target data set. The subject machine learning service takes images with classification labels as input and produces a customized classifier via supervised learning.

For example, 71 training jobs obtained from the subject machine learning service were randomly sampled, splitting each set of images with labels into 80% to use for fine-uning and 20% to use for validation. The 71 training data sets comprised a total of 18,000 images, with an average of 204 training images, and 50 held-out validation images each. There were 5.2 classes per classifier on average, with a range of 2 to 60 classes across classifiers. 14 neural network models trained from sub-domains of ImageNet were used as candidate neural network models for transfer learning, plus an additional “standard” neural network model was trained on all of the ImageNet-1K training data. Fine-tuning each of the 71 training jobs from each of the 15 initial neural network models resulted in 1065 neural network models. The performance of each neural network model was ranked by top-1 accuracy using 20% of the data that was held-out.

Furthermore, to assess the effect of the target data set size, the training set was cut in half for each and analyzed in a separate fine-tuning experiment. Thus, there were 102 training images per neural network model, but fine-tuning was not attempted if there were fewer than 15 training images available. Thus, 53 of the 71 training jobs were analyzed, with 15 initial conditions each, thereby producing an additional 795 fine-tuned neural network models, which evaluated with top-1 accuracy on the same validation data.

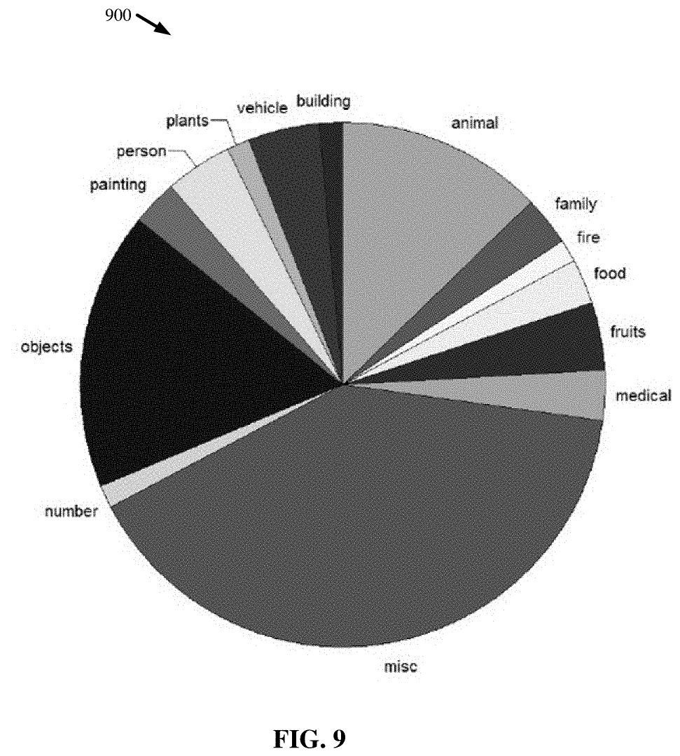

By manual inspection of the labels and/or classifier names given for the subject machine learning tasks, FIG. 9 shows an approximate breakdown of the types of image data in the subject sets. Repetitive description of like elements employed in other embodiments described herein is omitted for sake of brevity. FIG. 9 illustrates an diagram of an example, non-limiting pie chart 900 that can depict a distribution of vision custom learning workloads in accordance with one or more embodiments described herein. The portion of FIG. 9 labeled “misc” can be due to the fact that many labels given were opaque and/or had no obvious semantic meaning. The high level of variety shown in FIG. 9 is common in real-world custom learning service scenarios, since users are attempting to train custom classifiers for the reason that commonly available neural network models do not address the problems they are trying to solve.

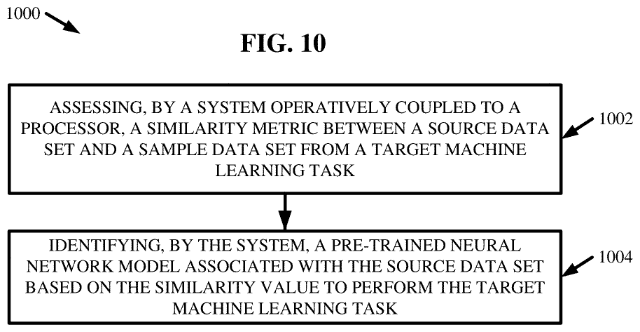

FIG. 10 illustrates a flow diagram of an example, non-limiting method 1000 that can facilitate assessment and/or identification of one or more pre-trained neural network models to serve as transfer models for one or more target machine learning tasks in accordance with the one or more embodiments described herein. Repetitive description of like elements employed in other embodiments described herein is omitted for sake of brevity.

At 1002, the method 1000 can comprise assessing (e.g., via the assessment component 112), by a system 100 operatively coupled to a processor 120, one or more similarity metrics between one or more source data sets and/or one or more sample data sets from one or more target machine learning tasks. The assessing at 1002 can compare the one or more source data sets and/or the one or more sample data sets using one or more distance computation techniques, as described herein.

At 1004, the method 1000 can comprise identifying (e.g., via the identification component 114), by the system 100, one or more pre-trained neural network models associated with the one or more source data sets based on the one or more similarity metrics to perform the one or more target machine learning tasks. In one or more embodiments, the identification component 114 can generate one or more charts, diagrams, and graphs to be presented to a user of the system 100 (e.g., via the one or more input devices 106 and/or the one or more networks 104) to facilitate selection of a transfer model. The one or more charts, diagrams, and graphs can depict, for example, one or more relationships characterized by the one or more similarity metrics. In one or more embodiments, the method 1000 can further comprise selecting (e.g., via the identification component 114) the one or more identified pre-trained neural network models to serve as transfer models to analyze the one or more target data sets.

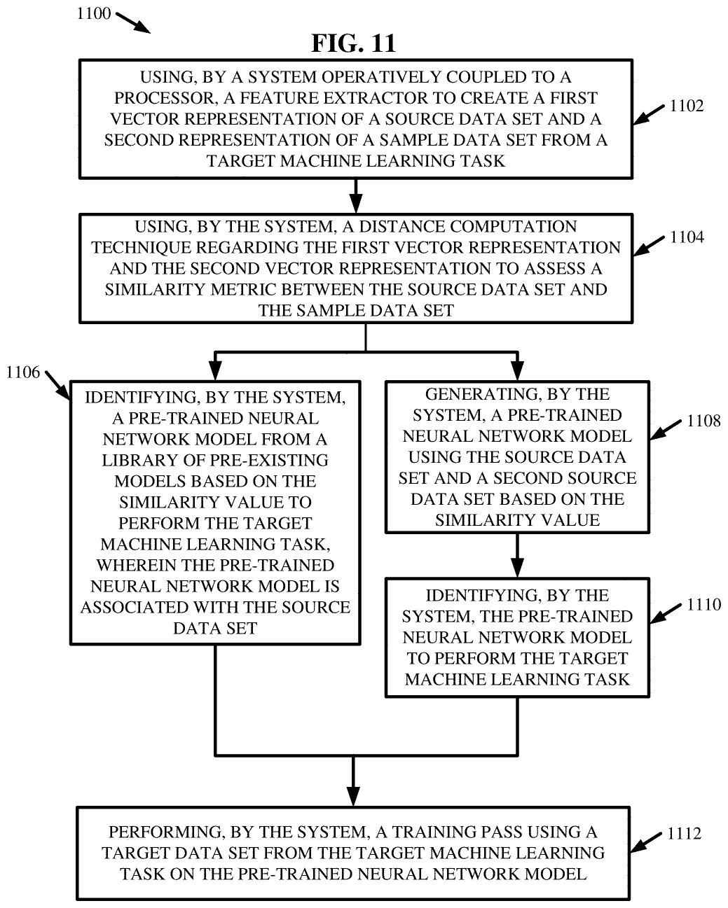

FIG. 11 illustrates a flow diagram of an example, non-limiting method 1100 that can facilitate assessment and/or identification of one or more pre-trained neural network models to serve as transfer models for one or more target machine learning tasks in accordance with the one or more embodiments described herein. Repetitive description of like elements employed in other embodiments described herein is omitted for sake of brevity.

At 1102, the method 1100 can comprise using (e.g., via the assessment component 112), by a system 100 operatively coupled to a processor 120, a feature extractor to create a first vector representation of one or more source data sets and a second vector representation of one or more sample data sets from one or more target machine learning tasks. At 1102, the feature extractor (e.g., via the assessment component 112) can extract one or more feature vectors from one or more layers of one or more pre-trained neural network models to create the first and/or second vector representations.

At 1104, the method 1100 can comprise using (e.g., via the assessment component 113), by the system 100, one or more distance computation techniques regarding the first vector representation and/or the second vector representation to assess one or more similarity metrics between the one or more source data sets and/or the one or more sample data sets. Example distance computation techniques can include, but are not limited to: KL-divergence, L2 distance, cosine similarity, Manhattan distance, Minkowski distance, Jaccard similarity, chi-square distance, a combination thereof, and/or the like. At 1104, the method 1100 can further comprise comparing (e.g., via the identification component 114) the one or more similarity metrics to identify one or more assessed pre-trained neural network models that were trained with data similar to the one or more target data sets and/or comprise one or more source data sets characterized by a similarity metric greater than a similarity threshold.

Wherein one or more pre-trained neural network models can be characterized by associated similarity metrics that are greater than the similarity threshold, the method 1100, at 1106, can comprise identifying (e.g., via the identification component 114), by the system 100, one or more pre-trained neural network models from a library of pre-existing models (e.g., library of models 122) based on the one or more similarity metrics to perform the one or more target machine learning tasks, wherein the pre-trained neural network model is associated with one or more of the source data sets assessed at 1102 and/or 1104. For example, at 1106 the method 1100 can comprise identifying (e.g., via the identification component 114) one or more pre-trained neural network models from a library of pre-existing neural network models as preferred transfer models based on the one or more similarity metrics, which can compare the source data sets of the pre-trained neural network models with the sample data sets of the target machine learning tasks. For instance, the one or more identified pre-trained neural network models can be selected by a user of the system 100 and/or autonomously selected by the identification component 114 to perform the one or more target machine learning tasks.

Wherein the assessed one or more pre-trained neural network models cannot be characterized by associated similarity metrics that are greater than the similarity threshold, the method 1100, at 1108, can comprise generating (e.g., via the identification component 114), by the system 100, one or more new pre-trained neural network models using one or more source data sets of a first pre-trained neural network model and one or more second source data sets of a second neural network model based on the similarity metrics. For example, at 1108 the method 1100 can comprise mixing and/or merging (e.g., via the identification component 114) one or more layers from a first neural network model with one or more layers from additional neural network models based on the respective similarity metrics associated with said layers. The one or more new pre-trained neural network models can be a combination of similar domain based neural network models or a combination of different domain based neural network models.

At 1110, the method 1100 can comprise identifying (e.g., via the identification component 114), by the system 100, the one or more neural network models generated at 1108 to perform the one or more target machine learning tasks. For example, the one or more identified pre-trained neural network models can be selected by a user of the system 100 and/or autonomously selected by the identification component 114 to perform the one or more target machine learning tasks.

At 1112, the method 1100 can comprise performing (e.g., via the training component 202), by the system 100, one or more training passes using one or more target data sets from the one or more target machine learning tasks on the one or more identified and/or selected pre-trained neural network models. Additionally, in one or more embodiments, the method 1100 can further comprise subjecting the one or more identified and/or selected pre-trained neural network models to one or more processing steps to fine-tune the subject pre-trained neural network model to the one or more target data sets. Example processing steps can include, but are not limited to: data normalization, data rotation, data scaling, a combination thereof, and/or like.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

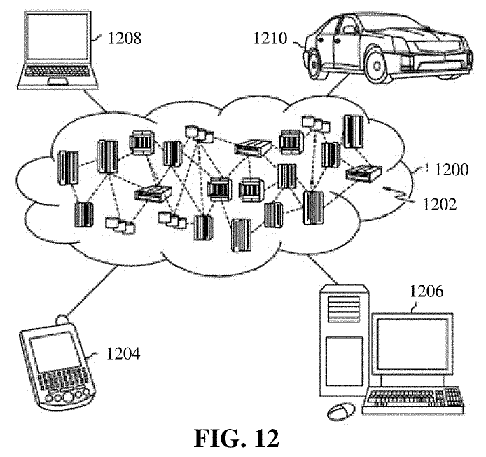

Referring now to FIG. 12, illustrative cloud computing environment 1200 is depicted. Repetitive description of like elements employed in other embodiments described herein is omitted for sake of brevity. As shown, cloud computing environment 1200 includes one or more cloud computing nodes 1202 with which local computing devices used by cloud consumers, such as, for example, personal digital assistant (PDA) or cellular telephone 1204, desktop computer 1206, laptop computer 1208, and/or automobile computer system 1210 may communicate. Nodes 1202 may communicate with one another. They may be grouped (not shown) physically or virtually, in one or more networks, such as Private, Community, Public, or Hybrid clouds as described hereinabove, or a combination thereof. This allows cloud computing environment 1200 to offer infrastructure, platforms and/or software as services for which a cloud consumer does not need to maintain resources on a local computing device. It is understood that the types of computing devices 1204-1210 shown in FIG. 12 are intended to be illustrative only and that computing nodes 1202 and cloud computing environment 1200 can communicate with any type of computerized device over any type of network and/or network addressable connection (e.g., using a web browser).

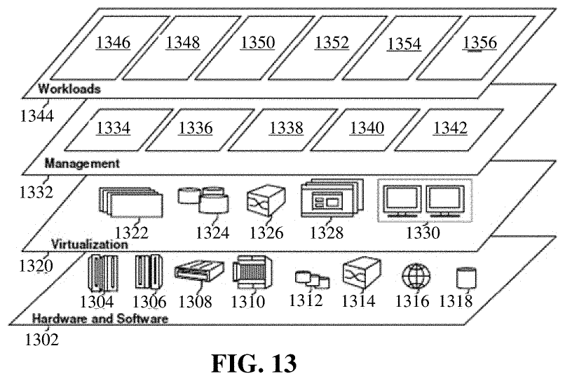

Referring now to FIG. 13, a set of functional abstraction layers provided by cloud computing environment 1200 (FIG. 12) is shown. Repetitive description of like elements employed in other embodiments described herein is omitted for sake of brevity. It should be understood in advance that the components, layers, and functions shown in FIG. 13 are intended to be illustrative only and embodiments of the invention are not limited thereto. As depicted, the following layers and corresponding functions are provided.

Hardware and software layer 1302 includes hardware and software components. Examples of hardware components include: mainframes 1304; RISC (Reduced Instruction Set Computer) architecture based servers 1306; servers 1308; blade servers 1310; storage devices 1312; and networks and networking components 1314. In some embodiments, software components include network application server software 1316 and database software 1318.

Virtualization layer 1320 provides an abstraction layer from which the following examples of virtual entities may be provided: virtual servers 1322; virtual storage 1324; virtual networks 1326, including virtual private networks; virtual applications and operating systems 1328; and virtual clients 1330.

In one example, management layer 1332 may provide the functions described below. Resource provisioning 1334 provides dynamic procurement of computing resources and other resources that are utilized to perform tasks within the cloud computing environment. Metering and Pricing 1336 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1338 provides access to the cloud computing environment for consumers and system administrators. Service level management 1340 provides cloud computing resource allocation and management such that required service levels are met. Service Level Agreement (SLA) planning and fulfillment 1342 provide pre-arrangement for, and procurement of, cloud computing resources for which a future requirement is anticipated in accordance with an SLA.

Workloads layer 1344 provides examples of functionality for which the cloud computing environment may be utilized. Examples of workloads and functions which may be provided from this layer include: mapping and navigation 1346; software development and lifecycle management 1348; virtual classroom education delivery 1350; data analytics processing 1352; transaction processing 1354; and transfer learning 1356. Various embodiments of the present invention can utilize the cloud computing environment described with reference to FIGS. 12 and 13 to facilitate identification, creation, and/or selection of one or more pre-trained neural network models for transfer learning.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

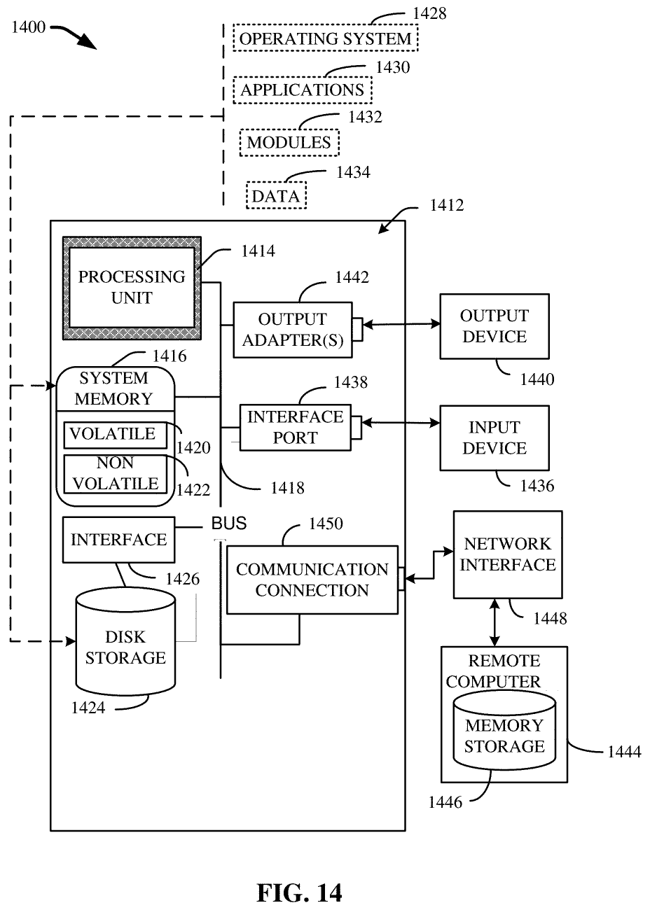

In order to provide a context for the various aspects of the disclosed subject matter, FIG. 14 as well as the following discussion are intended to provide a general description of a suitable environment in which the various aspects of the disclosed subject matter can be implemented. FIG. 14 illustrates a block diagram of an example, non-limiting operating environment in which one or more embodiments described herein can be facilitated. Repetitive description of like elements employed in other embodiments described herein is omitted for sake of brevity. With reference to FIG. 14, a suitable operating environment 1400 for implementing various aspects of this disclosure can include a computer 1412. The computer 1412 can also include a processing unit 1414, a system memory 1416, and a system bus 1418. The system bus 1418 can operably couple system components including, but not limited to, the system memory 1416 to the processing unit 1414. The processing unit 1414 can be any of various available processors. Dual microprocessors and other multiprocessor architectures also can be employed as the processing unit 1414. The system bus 1418 can be any of several types of bus structures including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire, and Small Computer Systems Interface (SCSI). The system memory 1416 can also include volatile memory 1420 and nonvolatile memory 1422. The basic input/output system (BIOS), containing the basic routines to transfer information between elements within the computer 1412, such as during start-up, can be stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1420 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1412 can also include removable/non-removable, volatile/non-volatile computer storage media. FIG. 14 illustrates, for example, a disk storage 1424. Disk storage 1424 can also include, but is not limited to, devices like a magnetic disk drive, floppy disk drive, tape drive, Jaz drive, Zip drive, LS-100 drive, flash memory card, or memory stick. The disk storage 1424 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1424 to the system bus 1418, a removable or non-removable interface can be used, such as interface 1426. FIG. 14 also depicts software that can act as an intermediary between users and the basic computer resources described in the suitable operating environment 1400. Such software can also include, for example, an operating system 1428. Operating system 1428, which can be stored on disk storage 1424, acts to control and allocate resources of the computer 1412. System applications 1430 can take advantage of the management of resources by operating system 1428 through program modules 1432 and program data 1434, e.g., stored either in system memory 1416 or on disk storage 1424. It is to be appreciated that this disclosure can be implemented with various operating systems or combinations of operating systems. A user enters commands or information into the computer 1412 through one or more input devices 1436. Input devices 1436 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 1414 through the system bus 1418 via one or more interface ports 1438. The one or more Interface ports 1438 can include, for example, a serial port, a parallel port, a game port, and a universal serial bus (USB). One or more output devices 1440 can use some of the same type of ports as input device 1436. Thus, for example, a USB port can be used to provide input to computer 1412, and to output information from computer 1412 to an output device 1440. Output adapter 1442 can be provided to illustrate that there are some output devices 1440 like monitors, speakers, and printers, among other output devices 1440, which require special adapters. The output adapters 1442 can include, by way of illustration and not limitation, video and sound cards that provide a means of connection between the output device 1440 and the system bus 1418. It should be noted that other devices and/or systems of devices provide both input and output capabilities such as one or more remote computers 1444.

Computer 1412 can operate in a networked environment using logical connections to one or more remote computers, such as remote computer 1444. The remote computer 1444 can be a computer, a server, a router, a network PC, a workstation, a microprocessor based appliance, a peer device or other common network node and the like, and typically can also include many or all of the elements described relative to computer 1412. For purposes of brevity, only a memory storage device 1446 is illustrated with remote computer 1444. Remote computer 1444 can be logically connected to computer 1412 through a network interface 1448 and then physically connected via communication connection 1450. Further, operation can be distributed across multiple (local and remote) systems. Network interface 1448 can encompass wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). One or more communication connections 1450 refers to the hardware/software employed to connect the network interface 1448 to the system bus 1418. While communication connection 1450 is shown for illustrative clarity inside computer 1412, it can also be external to computer 1412. The hardware/software for connection to the network interface 1448 can also include, for exemplary purposes only, internal and external technologies such as, modems including regular telephone grade modems, cable modems and DSL modems, ISDN adapters, and Ethernet cards.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components including a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
an assessment component that assesses a similarity metric between a source data set and a sample data set from a target machine learning task; and
an identification component that identifies a pre-trained neural network model associated with the source data set based on the similarity metric to perform the target machine learning task.

2. The system of claim 1, wherein the assessment component uses a feature extractor and a statistical aggregation technique to create a first vector representation of the source data set and a second vector representation of the sample data set, and wherein the assessment component assesses the similarity metric using a distance computation technique regarding the first vector representation and the second vector representation.

3. The system of claim 2, wherein the distance computation technique is selected from a group consisting of Kullback-Leibler divergence, Euclidean distance, cosine similarity, Manhattan distance, Minkowski distance, Jenson Shannon distance, chi-square distance, and Jaccard similarity.

4. The system of claim 2, wherein the statistical aggregation technique is selected from a group consisting of a mean average, a code book, a standard deviation, and a median average.

5. The system of claim 1, further comprising:
a training component that performs a training pass using a target data set from the target machine learning task on the pre-trained neural network model.

6. The system of claim 1, wherein the identification component identifies the pre-trained neural network model from a library of pre-existing models.

7. The system of claim 1, wherein the source data set is comprised within a plurality of source data sets, wherein the assessment component assesses the similarity metric between the plurality of source data sets and the sample data set, and wherein the identification component further generates the pre-trained neural network model using the source data set and a second source data set from the plurality of source data sets.

8. The system of claim 7, wherein the source data set is associated with a vision-based model and the second source data set is associated with a knowledge-based model.

9. The system of claim 1, wherein the assessment component assesses the similarity metric in a cloud computing environment.

10. The system of claim 1, wherein the identification component further applies a data processing technique to the pre-trained neural network model, and wherein the data processing technique is selected from a group consisting of data normalization, data rotation, and data scaling.

11. A computer-implemented method, comprising:
assessing, by a system operatively coupled to a processor, a similarity metric between a source data set and a sample data set from a target machine learning task; and
identifying, by the system, a pre-trained neural network model associated with the source data set based on the similarity metric to perform the target machine learning task.

12. The computer-implemented method of claim 11, wherein the assessing further comprises:
using, by the system, a feature extractor to create a first vector representation of the source data set and a second vector representation of the sample data set; and
using, by the system, a distance computation technique regarding the first vector representation and the second vector representation to assess the similarity metric.

13. The computer-implemented method of claim 12, wherein the distance computation technique is selected from a group consisting of Kullback-Leibler divergence, Euclidean distance, cosine similarity, Manhattan distance, Minkowski distance, Jenson Shannon distance, chi-square distance, and Jaccard similarity.

14. The computer-implemented method of claim 11, further comprising performing, by the system, a training pass using a target data set from the target machine learning task on the pre-trained neural network model.

15. The computer-implemented method of claim 11, wherein the identifying comprises identifying, by the system, the pre-trained neural network model from a library of pre-existing models.

16. The computer-implemented method of claim 11, further comprising:
assessing, by the system, the similarity metric between a plurality of source data sets and the sample data set, wherein the source data set is comprised within the plurality of source data sets; and
generating, by the system, the pre-trained neural network model using the source data set and a second source data set from the plurality of source data sets.

17. A computer program product that facilitates using a pre-trained neural network model to enhance performance of a target machine learning task, the computer program product comprising a computer readable storage medium having program instructions embodied therewith, the program instructions executable by a processor to cause the processor to:
assess, by a system operatively coupled to the processor, a similarity metric between a source data set and a sample data set from the target machine learning task; and
identify, by the system, the pre-trained neural network model associated with the source data set based on the similarity metric to perform the target machine learning task.

18. The computer program product of claim 17, wherein the program instructions executable by the processor further cause the processor to:
use, by the system, a feature extractor to create a first vector representation of the source data set and a second vector representation of the sample data set; and
use, by the system, a distance computation technique regarding the first vector representation and the second vector representation to assess the similarity metric.

19. The computer program product of claim 18, wherein the program instructions executable by the processor further cause the processor to identify, by the system, the pre-trained neural network model from a library of pre-existing models.

20. The computer program product of claim 18, wherein the program instructions executable by the processor further cause the processor to:
assess, by the system, the similarity metric between a plurality of source data sets and the sample data set, wherein the source data set is comprised within the plurality of source data sets; and
generate, by the system, the pre-trained neural network model using the source data set and a second source data set from the plurality of source data sets.
